(19) United States
(12) Patent Application Publication
(10) Pub. No.: US 2014/0351080 A1
(43) Pub. Date: Nov. 27, 2014

(54) SYSTEM AND METHOD FOR JOINT SHOPPING CART

(71) Applicant: RETRY LLC, New York, NY (US)

(72) Inventor: Jack LOWINGER, Lawrence, NY (US)

(73) Assignee: RETRY LLC, New York, NY (US)

(21) Appl. No.: 14/032,836

(22) Filed: Sep. 20, 2013

Related U.S. Application Data
(60) Provisional application No. 61/827,105, filed on May 24, 2013.

(51) Int. Cl. G06Q 30/06

(52) U.S. Cl. CPC G06Q 30/0633
USPC 705/26.8

(57) ABSTRACT

A method and system may include receiving input, by a processor, from a first user. The input may describe one or more items sold by a retailer, and the first user may be part of a group of users. The method may include adding the one or more items to a shopping cart associated with the group of users. The method may further include assigning at least one administrative function to each user of the group of users and displaying administrative functions of the shopping cart to each user of the group of users, based on each user's assigned administrative function.

### CROSS REFERENCE TO RELATED APPLICATIONS

This application claims benefit of U.S. Provisional Patent application No. 61/827,105 filed on May 24, 2013 which is incorporated herein by reference in its entirety.

### FIELD OF THE PRESENT INVENTION

The present invention relates generally to the field of online shopping.

### BACKGROUND

Virtual shopping carts may be commonly used applications for shopping or e-commerce websites. For example, different retailers such as Amazon.com, Ebay, or Best Buy may include a shopping cart on their websites to allow purchasers to add desired purchase items, goods or services to a list that is associated with them. The shopping cart may allow purchasers to review and edit their total order before placing a purchase. The shopping cart may save a purchaser time since payment information need only be entered once for all items, instead of for each item.

However, shopping carts may have limited functionality by allowing only one purchaser to access the shopping cart and allowing only one retailer, typically the website owner, to sell items to the purchaser. For groups and organizations, shopping carts may requiring sharing between users in order to share information and adequately capture every user's needs. Using the same account for all users in a group or organization may confuse a website's systems and may cause confusion among the users.

### SUMMARY

A method and system may include receiving input, by a processor, from a first user. The input may describe one or more items sold by a retailer, and the first user may be part of a group of users. The method may include adding the one or more items to a shopping cart associated with the group of users. The method may further include assigning at least one administrative function to each user of the group of users and displaying administrative functions of the shopping cart to each user of the group of users, based on each user's assigned administrative function.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram of a shopping website system, according to embodiments of the invention.

FIG. 2 is a diagram of user functions associated with a shopping cart, according to embodiments of the invention.

FIG. 3 is a diagram of user functions associated with a shopping cart in registry mode, according to embodiments of the invention.

FIG. 4 is a flowchart of a method, according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

Embodiments of the invention may manipulate data representations of real-world entities such as products being sold via the Internet. Embodiments of the invention may process and organize this data representing real-world entities, transmit such data among various entities, provide recommendations based on such data, allow users to access or search the data, and present the data to users.

As used herein, the term ‘website’ may include one or more web-based or virtual pages having content thereon that may be or include text, data, images and video organized under one or a series of related web domain names or URL's (Uniform Resource Locators). Such web pages may be accessed by and presented to a remote user or visitor of the web site by way of for example a web server that may transmit data making up the web site to a user's computer for presentation on a screen or viewer (e.g., the user computer may execute a browser to display the web site). Content included or presented in pages of the web site may include words, terms, phrases, images, sounds, video or other depictions of information related to one or more topics.

Embodiments of the invention may provide for a virtual shopping cart that allows multiple users or customers to add to or edit a shopping list and place orders on items in the virtual shopping cart. An item may be any physical good sold by a retailer, or a service such as cleaning services, for example. In some embodiments each cart may belong to or may be controlled by a group in which users have different administrative rights over the cart and can change the cart in different ways. Users may be able to participate concurrently in multiple carts across a variety of groups that they belong to. When used herein, a shopping list or shopping cart may be a data construct which may be presented to a user or multiple users e.g. on a monitor displaying items which when an order is completed, executed or purchased, will be purchased and shipped or otherwise sent to a user or users. Items or goods may be added or deleted to a shopping cart by having a data representation of the item added to the data construct representing the shopping cart. A group or set of users may be related by being in the same corporation or organization, or may be in the same social group. Users may associate themselves with a group by having a common interest or goal.

The virtual shopping carts or lists may allow households, businesses, organizations, and groups to create a single shopping cart to which multiple users or members in the group can add items. The single shopping cart may store or reference items from multiple physically and organizationally separate sellers. By storing or referencing items from different sellers or retailers, users that are part of a group may be able to consolidate their purchases to save time. The consolidation may allow organizations to enter account information only once, instead of multiple times for each retailer. The consolidation may also save time by reducing the amount of planning and communication needed to coordinate purchases among users in a group. The final order may be reviewed by an administrator or other users (e.g. inventory manager, parent, executive director, etc.) having authorization to complete the order and pay with an account linked to the shopping cart.

The virtual shopping cart may be implemented as a standalone app or application as well as be functionally integrated into individual store websites of distinct sellers (e.g. Amazon, Staples, etc.) or into checkout programs such as Paypal and Google Wallet. Application Programming Interface (API) libraries may be used to integrate the shopping cart function into existing websites. The shopping cart may be linked to a comprehensive searchable database of available products from various providers or online retailers. Bar code functionality may be used for any smartphone versions of the program. For example, a smartphone may be able to interpret a bar code on a product, and add the product to a shopping cart within an application. In some embodiments, integration and communication with third parties (e.g. retailers, online providers, etc.) may be through API's that provide access to product information including current pricing and inventory as well as retailer shopping carts, e.g., via the Internet. Payment may be handled by third party retailer sites, which may be viewable as a window nested on a website hosted by a main server which may in addition manage the shopping cart. Some embodiments may manage a relatively large base of users while collecting little in the way of personal information from them. In some embodiments it may be required that users have existing account set up with our retail partners. Users may be able to log into the shopping website with a username and password, and may be linked to various groups and payment accounts, for example.

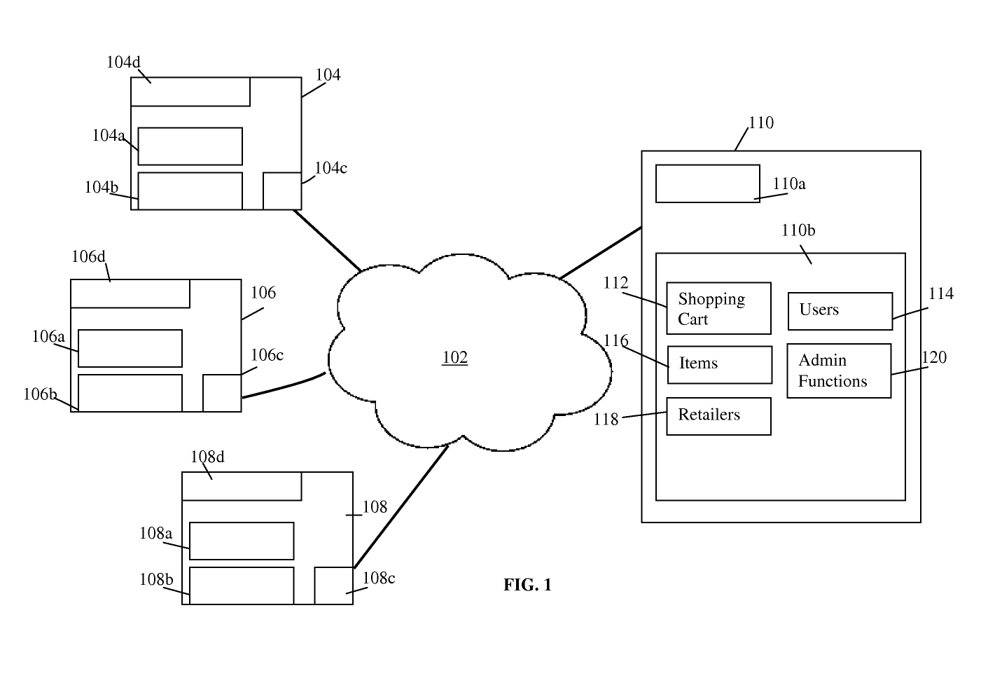

FIG. 1 is a diagram of a shopping system, according to embodiments of the invention. Via one or more computer systems 104, 106, and 108, users may connect to a server 110 through a computer network 102, such as the Internet. A user, customer, or member may be part of a group or set of other users that are subscribed or associated with a shopping cart 112 or shopping list. Server 110 may host a shopping or e-commerce website for example. The server 110 may include one or more processors 110a configured to run or execute software to implement a shopping website. The server 110b may also include memory to store data or computer-executable instructions to carry out the methods disclosed herein. Data stored may include shopping carts 112, user information 114, items, goods or services 116 for purchase (when discussing storing or manipulating, such as by adding or removing, objects such as items or other objects, data or descriptions representing the items are typically stored, e.g. in a memory, or manipulated, e.g. by a processor), information describing retailers 118 associated with the items, and administrative functions 120 associated with each user. Data may be stored in a table or other data structure that illustrates associations or relationships been each of the shopping carts 112, user information 114, items 116, retailers 118, and administrative functions 120. A shopping cart 112 may in some embodiments be, instead of a data structure, an application or app executed by one or more of server 110 or computer systems 104, 106, and 108.

Each of computer systems 104, 106, and 108, and server 110 may include components such as processors or controllers 104a, 106a, 108a, and 110a, memories 104b, 106b, 108b, and 110b such as long term or short term storage (e.g., hard disk drive, removable memory, random access memory etc.). Computer systems 104, 106, and 108 may include input/output (I/O) devices such as monitors, keyboards, pointing devices (e.g., mouse, etc.) 104c, 106c, and 108c.

Users using computers 104, 106, and 108 may be a group of users associated with a shopping cart 112, for example. Other users may also be part of the group, or other users may be added by existing users in the group. Through a user interface implemented by processors 104a, 106a, and 108a, and input/output devices 104c, 106c, and 108c, computers 104, 106, and 108 may receive input from users describing or specifying one or more items, products or services sold by a seller or retailer. The items or articles may be stored in memory as a description of the item, such as a photo, retailer, price, or other information. Users on computer 104, 106, and 108 may be able to add (e.g., enter input causing the computers to add, by altering data representing items) one or more desired items 116 for purchase to the shopping cart 112 (As discussed, when manipulating by for example adding, deleting, purchasing, etc., items, a data representation of the item is typically manipulated and stored.). Each item 116 may, for example, be associated or connected to a retailer or seller which sells and ships the item once the item is purchased. Users on computer 104, 106, and 108 may have different administrative functions 120 assigned to them, e.g., by computers 104, 106, 108 or server 110. Different users may have different administrative functions. The administrative functions 120 allow the users to perform different tasks related to the shopping cart 112 (e.g., by entering input causing the computers to perform these functions), such as removing items from the cart or purchasing the items. In some embodiments, the group of users may include one or more administrators which are able to view all items added to the shopping cart 112 and checkout or purchase the items, or perform other tasks. By assigning administrative functions, the administrator may be able to perform more tasks than other users in the group, for example, such as setting the administrative functions of other users in the group. Some user may be unable, for example to purchase items or view all items in a cart. All users may be able to view different administrative functions on a monitor or display 104d, 106d, and 108d, based on each user's assigned administrative functions. For example, users on computer 104 and 106 may be assigned an administrative function of viewing all items in the cart and adding items to the cart. Users may be stored in a database entry representing the user and the user may be linked or assigned another data entry which describes the administrative function. Monitors 104d and 106d may display or show the items associated or added to the shopping cart to the users and may display a button alongside each item searched indicating an ‘add’ function. Users may enter input to computers such as 104 and 106 by typing at a keyboard or using a pointing device to “click” or otherwise indicate on buttons, icons, or other displays. User on (using) computer 108 may be, for example, an administrator who is allowed to purchase items in or associated with the shopping cart. A checkout button or user interface item may be displayed on monitor 108d next to shopping cart. Other user interface configurations may be used to display administrative functions to different users.

Computers 104, 106, and 108 may be for example personal computers, workstations, smartphones, simple terminals, or other sorts of computer systems, and may include components and capabilities other than what is shown in the examples provided.

Computer systems such as computer systems 104, 106, and 108, and server 110 may carry out embodiments of the present invention. For example, processors or controllers 104a, 106a, 108a, and 110a may collectively or individually be configured to carry out embodiments of the invention by, for example, executing software or code stored for example in memory 104b, 106b, 108b, or 110b. For example, users or administrators purchasing or adding items or articles to a shopping cart may use computer systems 104, 106, and 108 which may operate web browsers to interface with users or administrators, and which may access on-line sales websites operated for example by server 110. Server 110 may store a shopping list or shopping cart for example in memory 110b. Server 110 may include social networking capacity so people can discuss lists, form co-shopping groups, and organize events. Such capabilities may be performed by one or more servers, or other devices.

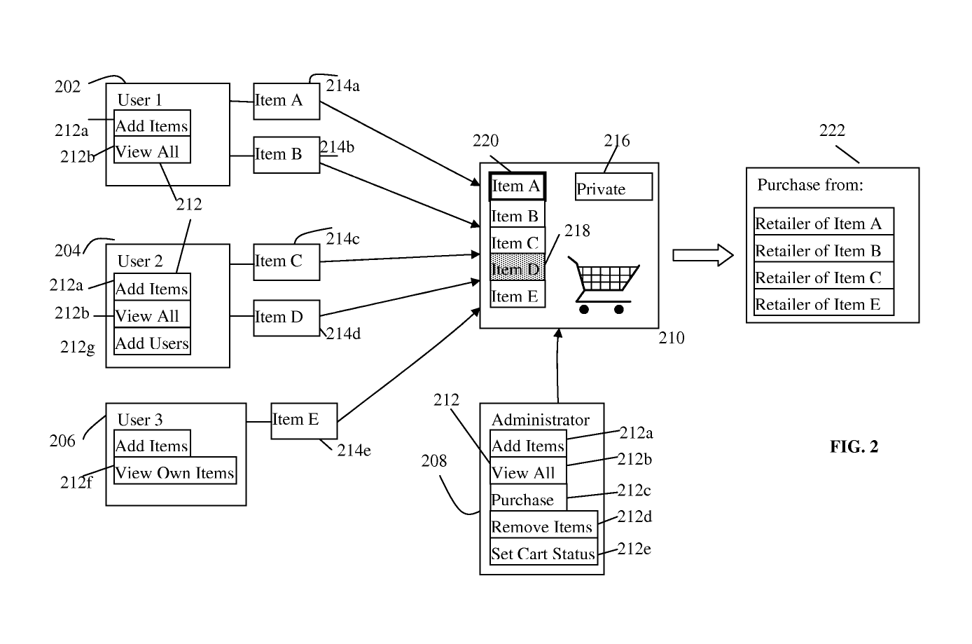

FIG. 2 is a diagram of user functions associated with a shopping cart, according to embodiments of the invention. A first user 202, a second user 204, a third user 206, and a fourth user or administrator 208 may be members of a group associated with a shopping cart 210. The group may be employees of a corporation desiring to purchase office supplies, for example, or a family wishing to purchase items or goods such as groceries, pharmacy items, school supplies or other household items. Each of the users 202, 204, 206, and 208 may have different administrative functions 212 assigned or appointed to them. These administrative functions may be assigned by the administrator 208, for example, and may depend on the shopping mode which the shopping cart or system is in, for the particular group of users. A shopping mode may be, for example, party mode, where multiple users may add items to a shopping cart, and multiple users may purchase from the shopping cart. Another mode may be registry mode, where one user adds items, and multiple other users purchase the items. Other modes may exist, and different administrative functions may exist depending on the desired mode.

As shown, for example, the first, second, and third user may be assigned the “add items” function 212a. These users may be able to add desired items to the shopping cart 210. Through a computer and a user interface, for example, the users may search for items available in a database provided by a shopping website (hosted on server 110 in FIG. 1, for example). The users may add items to the shopping cart by instructing the shopping website to associate the items with the shopping cart, or insert the item in a list. The first user 202 may add Item A 214a and Item B 214b to the shopping cart 210, the second user 204 may add Item C 214c and Item D 214e to the shopping cart 210, and the third user 206 may add Item E 214e to shopping cart 210.

In some embodiments, the administrator 212 may be assigned more functions than the first, second, and third user, for example. As shown, the administrator 212 may be able to add items 212a, view all items 212b, purchase items 212c, remove items 212d from the shopping cart (e.g., disassociate the items), and set cart status 212e, such as whether the shopping cart 210 is public or private 216. As a private shopping cart 210, the shopping cart's items may be viewed by the group associated with the shopping cart 210, and may exclude other users on the shopping website from reviewing items. The administrator may, for example, remove item D from the cart, as illustrated by a shaded Item D 218. The administrator may also set the status of some items as a collective item, which may be viewed by all users, regardless of their administrative function. For example, Item A 220 may be set as a collective item by the administrator 208. Collective items may be items that are commonly ordered among users in the group and used collectively, such as toilet paper or printing ink. Setting the status of a collective item may prevent double orders between users. The first and second user 204, 206 may be assigned the administrative function of ‘view all’ 212b or viewing all items in or associated with the shopping cart. After the administrator 208 removes Item D from the shopping cart 210, the first and second user 204, 206 may be able to view Item A, Item B, Item C, and Item E in the shopping cart 210. The third user 206 may be assigned an administrative function of ‘view own items’ 212f or viewing items only added by the third user 206 (e.g., Item E 214e). Since Item A 220 may be set as a collective item, third user 206 may be able to view Item A 220 and Item E 214e in the shopping cart. The second user 204 may be able to add other users 212g to the group associated with shopping cart 210.

Once administrator 208 is finished editing the shopping cart (e.g., removing Item D 218 or adding other items), the administrator 208 may instruct the shopping website or program to purchase the items listed in the shopping cart 210. The shopping website may maintain or store a list of retailers (e.g., in memory 110b in FIG. 1) associated with each item. According to the items listed in the shopping cart 210, the website may then automatically (e.g., by being executed by a processor such as processor 110a) purchase Items A, B, C, and E 222 from their respective retailers on behalf of the group of first, second, third, and fourth users. The website may store account information for the group and send the group's payment information to each respective seller or retailer, for example. The website may interface with individual sellers or retailers through the conventional user interface users use when accessing those retailers or sellers, or through a special API. The individual sellers or retailers may then ship the items to the address stored by the website. The individual sellers, for example, may reference a database stored by the website to gain access to shipping information. Alternatively, the individual sellers or retailers may store customer shipping information on their own servers or websites, and the shopping website may access shipping information from the individual sellers. In such a manner, one consolidated shopping cart may be accessed by one or more users, the one shopping cart allowing access to more than one physically and/or organizationally separate seller. Each separate seller may have a different user interface or sales requirements, and the consolidated shopping cart may allow a user to avoid repeatedly entering purchase information. The shopping cart also allows administrative users (e.g., office managers, parents, etc.) to save on costs for their organization by being able to edit and track the shopping behavior of non-administrative users (e.g., ordinary employees, children, etc.). This could potentially obviate the need for companies/parents to provide payment account information or credit cards to employees/children.

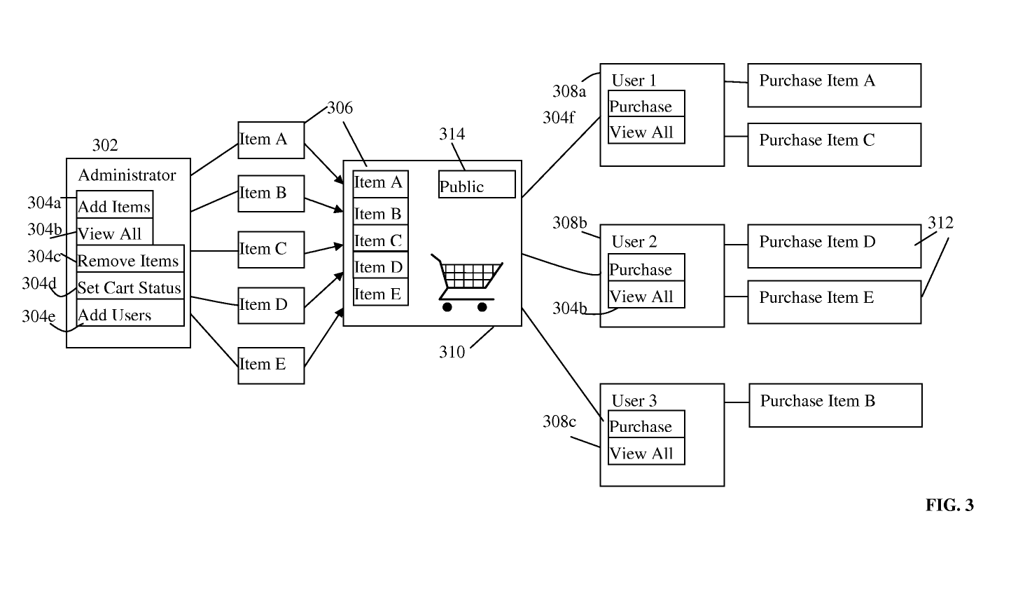

FIG. 3 is a diagram of user functions associated with a shopping cart in registry mode, according to embodiments of the invention. Registry mode may be applicable for gift giving events, such as birthdays or weddings, for example. An administrator user 302 may be assigned administrative functions including adding items 304a, viewing all items, 304b, removing items 304c, setting the cart status 304d, or adding users 304e. The administrator 302 may select items 306 that the administrator 302 desires to be purchased for them, and add the items 306 to a shopping cart 310. The administrator 302 may select users 308a 308b, 308c to be associated with the administrator 302. The users 308a 308b, 308c may be assigned administrative functions allowing them to purchase items 304f and view all items 304b. The items displayed to users 308a, 308b, 308c and administrator 302 may include information or descriptions such as price, retailer, brand, specifications, or reviews from other purchasers, for example. Users 308a, 308b, 308c may purchase items off of shopping cart 310 for administrator 302. For example, User 2 308b may purchase Items D and E 312 from User 2's own funds, e.g., using a credit card or bank account. Administrator 302 may set shopping cart 310 status to public 314, allowing all users, including users outside of the group associated with shopping cart 310, to view the items 306 added by administrator 302.

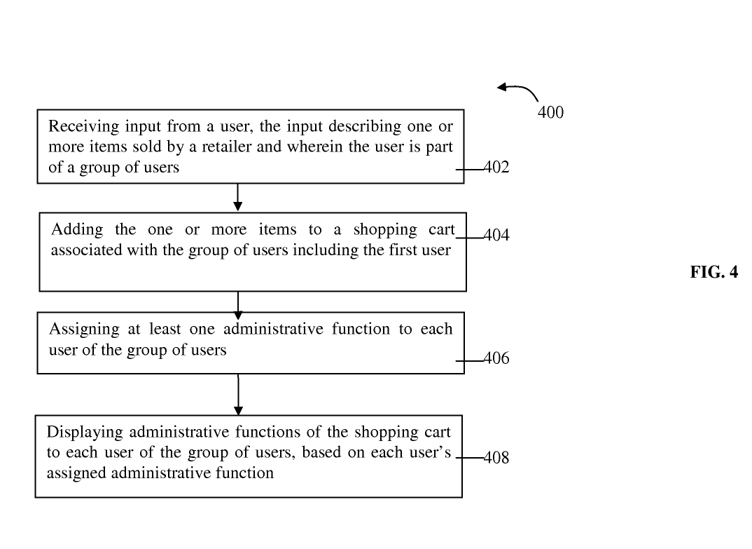

FIG. 4 is a flowchart of a method, according to embodiments of the invention. In operation 402, a shopping website or system may receive input from a user. The input may describe one or more items sold by a retailer. The user may be part of a group of users, such as a family, friends, members of an organization such as a church or parents of children at a certain school, or employees of a corporation. In operation 404, the users, through a processor, may add the one or more items to a shopping cart associated with the group of users. The shopping cart may be virtual or represented by a data structure in memory. The shopping cart may display or be related to a list of items added by the users. In operation 406, a processor may assign at least one administrative function to each user in the group of users. One or more of the users may be an administrator and may be assigned more administrative functions than the other users in the group, or may be assigned certain administrative functions no or few others have assigned, for example, editing the items in the cart and ordering or purchasing the items in the shopping cart. The administrative functions may be assigned by default upon creation of a shopping cart, or the functions may be assigned by the administrator. In operation 408, the administrative functions of the shopping cart may be displayed (e.g., on a monitor) to each user in the group of users, based on the user's assigned administrative functions. For example, a user who can add items and view all items may be able to view all items added to the shopping cart by all other users. The user may also be able to view and interact with a user interface element, such as a button, allowing the user to add an item to the shopping cart. An administrator able to purchase an item may be able to view a button to allow the administrator to purchase the shopping cart items with an account linked to the group.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein

Unless explicitly stated, the method embodiments described herein are not constrained to a particular order or sequence. Additionally, some of the described method embodiments or elements thereof can occur or be performed at the same point in time. While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein.

1. A method, comprising:
receiving input, by a processor, from a first user, the input describing one or more items sold by a retailer and wherein the first user is part of a group of users;
adding, by the processor, the one or more items to a shopping cart associated with the group of users including the first user;
assigning, by the processor, at least one administrative function to each user of the group of users; and
displaying administrative functions of the shopping cart to each user of the group of users, wherein the displayed administrative functions differ based on each user's assigned administrative function.

2. The method of claim 1, comprising receiving instructions from an administrator of the group of users to purchase the one or more items in the shopping cart.

3. The method of claim 1, comprising adding users to the group of users associated with the shopping cart.

4. The method of claim 1, comprising receiving instructions from an administrator of the group of users to remove an item from the shopping cart.

5. The method of claim 1, wherein the at least one administrative function includes at least one of: adding items to the shopping cart, viewing items added by a user, viewing items added by all users, setting the shopping cart as private or public, and purchasing items from the shopping cart.

6. The method of claim 1, wherein the input further describes a plurality of items sold by a plurality of retailers.

7. The method of claim 1, comprising assigning a public status to some items added to the shopping cart.

8. The method of claim 7, comprising displaying the items with a public status to all users in the group of users.

9. A device, comprising a processor and memory, the processor configured to:
receive input from a first user, the input describing one or more items sold by a retailer and wherein the first user is part of a group of users;
add the one or more items to a shopping cart shared by the group of users including the first user;
assign at least one administrative function to each user of the group of users; and
display administrative functions of the shopping cart to each user of the group of users, wherein the displayed administrative functions differ based on each user's assigned administrative function.

10. The device of claim 9, where the processor is configured to receive instructions to purchase the one or more items in the shopping cart from an administrator of the group of users.

11. The device of claim 9, wherein the processor is configured to receive input from a plurality of users in the group of users, the input describing a plurality of items sold by a retailer.

12. The device of claim 9, wherein the processor is configured to receiving instructions from an administrator of the group of users to remove an item from the shopping cart.

13. The device of claim 9, wherein the at least one administrative function includes at least one of: adding items to the shopping cart, viewing items added by a user, viewing items added by all users, setting the shopping cart as private or public, and purchasing items from the shopping cart.

14. The device of claim 9, wherein the input further describes a plurality of items sold by a plurality of retailers.

15. The device of claim 9, wherein the processor is configured to assign a public status to some items added to the shopping cart.

16. A shopping network system, comprising:
a memory configured to store descriptions of a plurality of items sold by one or more retailers;
a processor configured to:
receive instructions from a plurality of users to add one or more of the plurality of items to a group shopping cart;
display items to authorized users of the plurality of users;
display administrative functions of the group shopping cart to each user of the plurality of users, wherein the displayed administrative functions differ based on each user's assigned administrative function; and
receive instructions from an administrator of the plurality of users to purchase the items added to the group shopping cart, wherein an administrative function to purchase items is only displayed to administrators of the plurality of users.

17. The shopping network system of claim 16, wherein the processor is configured to receive instructions from the administrator to remove an item from the group shopping cart.

18. The shopping network system of claim 16, wherein the processor is configured to associate authorized users with at least one administrative functions.

19. The shopping network system of claim 18, wherein the at least administrative function includes at least one of: adding items to the shopping cart, viewing items added by a user, viewing items added by all users, setting the shopping cart as private or public, and purchasing items from the shopping cart.

20. The shopping network system of claim 16, wherein the memory is configured to store the authorization status of each the plurality of users.
